(19) United States
(12) Patent Application Publication
(10) Pub. No.: US 2026/0140694 A1
(43) Pub. Date: May 21, 2026

(54) METHODS FOR ARBITRATING WAKE WORD DETECTION AT A PLURALITY OF DEVICES AND SYSTEMS OF USE THEREOF

(71) Applicant: Meta Platforms Technologies, LLC, Menlo Park, CA (US)

(72) Inventors: Yuhui Lin, Kirkland, WA (US); Marcin Kwiatkowski, San Francisco, CA (US); Rahul Yogendra Verma, Newark, CA (US); Serhat Yilmaz, San Mateo, CA (US)

(21) Appl. No.: 19/396,199

(22) Filed: Nov. 20, 2025

Related U.S. Application Data
(60) Provisional application No. 63/722,971, filed on Nov. 20, 2024.

(51) Int. Cl. G06F 3/16; G06F 1/16

(52) U.S. Cl. CPC G06F 3/167; G06F 1/163

(57) ABSTRACT

A method for arbitrating wake word detection at a head-wearable device and a wrist-wearable device is described herein. The method includes, in accordance with a determination that the head-wearable device is in a first state: (i) causing the head-wearable device to detect a first voice command from a user, (ii) causing the wrist-wearable device to forgo detecting the first voice command, and (iii) causing the head-wearable device to present a first response, based on the first command. The method further includes, in accordance with a determination that the head-wearable device is in a second state and a determination that the wrist-wearable device is in a first state: (i) causing the head-wearable device to forgo detecting a second voice command from the user, (ii) causing the wrist-wearable device to detect the second voice command, and (iii) causing the wrist-wearable device to present a second response, based on the second command.

### TECHNICAL FIELD

This application claims priority to U.S. Provisional Application Ser. No. 63/722,971, filed Nov. 20, 2024, entitled “Methods For Arbitrating Wake Word Detection At A Plurality Of Devices And Systems Of Use Thereof,” which is incorporated herein by reference.

### TECHNICAL FIELD

This relates generally to arbitrating wake word detection at wearable devices, in accordance with some embodiments.

### BACKGROUND

Existing smart devices include simple or artificially intelligent (AI) assistants that respond to and perform tasks based on voice commands make by users. When users wear multiple smart devices, it is not desirable for an assistant to respond to the user commands on all of the smart devices. Existing technology does not provide a solution for arbitrating assistant invocations and voice commands on multiple wearable devices, leading to confusion and inefficiency in interactions with assistants. Additionally, assistants on multiple devices responding to a voice command creates an inefficient use of computing and battery resources that limits the use of the user's smart devices. It is preferable, for the user experience, for the assistant to listen to the voice commands and respond to the voice commands at one device.

As such, there is a need to address one or more of the above-identified challenges. A brief summary of solutions to the issues noted above are described below.

### SUMMARY

One example of arbitrating wake word detection at a plurality of devices is described herein. This example method occurs at a system including a head-wearable device, a wrist-wearable device, and/or another device with one or more displays speakers, one or more microphones, and/or one or more non-transitory, computer-readable storage media including executable instructions for performing operations. The operations include, while the head-wearable device is communicatively coupled to the wrist-wearable device and in accordance with a determination that the head-wearable device is in a first head-wearable device state: (I) causing the head-wearable device to detect a first voice command from a user, (ii) causing the wrist-wearable device to forgo detecting the first voice command, and (iii) causing the head-wearable device to present a first response, based on the first voice command, to the user. The operations further include, while the head-wearable device is communicatively coupled to the wrist-wearable device and in accordance with a determination that the head-wearable device is in a second head-wearable device state and a determination that the wrist-wearable device is in a first wrist-wearable device state: (i) causing the head-wearable device to forgo detecting a second voice command from the user, (ii) causing the wrist-wearable device to detect the second voice command, and (iii) causing the wrist-wearable device to present a second response, based on the second voice command, to the user.

In some embodiments, (i) the determination that the head-wearable device is in the first head-wearable device state includes determining that the head-wearable device is being worn by the user, (ii) the determination that the head-wearable device is in the second head-wearable device state includes determining that the head-wearable device is not being worn by the user, and (iii) the determination that the wrist-wearable device is in the first wrist-wearable device state includes determining that the wrist-wearable device is being worn by the user.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an example of a user interacting with an artificially intelligent (AI) assistant at a plurality of devices, in accordance with some embodiments.

FIG. 2 illustrates an example system diagram for a head-wearable device indicating, to a wrist-wearable device), a current state of the head-wearable device, in accordance with some embodiments.

FIGS. 3A-3D illustrate the user interacting with the AI assistant at the head-wearable device, the wrist-wearable device, and the one or more other devices, based on the respective states of the plurality of devices, in accordance with some embodiments.

FIG. 4 shows an example method flow chart for arbitrating wake word detection at a plurality of devices, in accordance with some embodiments.

FIGS. 5A, 5B, and 5C-1 and 5C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Wake Word Arbitration at a Plurality of Wearable Devices

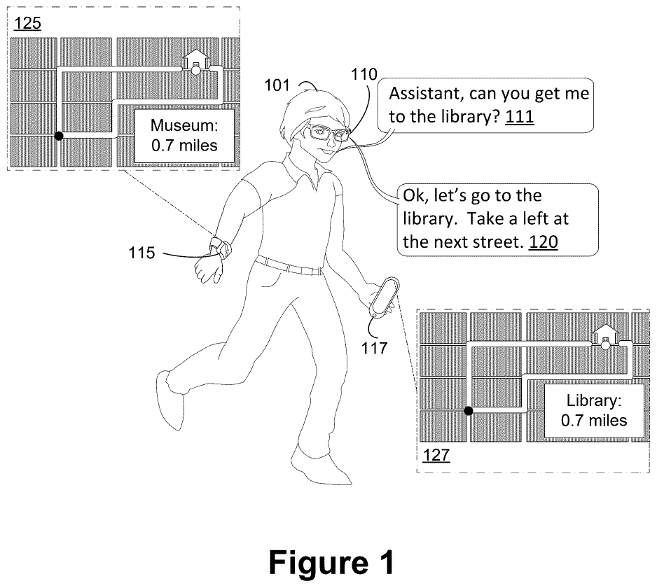

FIG. 1 illustrates an example of a user 101 interacting with an AI assistant at a plurality of devices, in accordance with some embodiments. In some embodiments, the plurality of devices includes a head-wearable device 110 (e.g., a pair of smart glasses, an extended-reality (XR) headset, and/or an augmented-reality (AR) headset), a wrist-wearable device 115 (e.g., a smart watch), and one or more other devices (e.g., a smartphone 117, a handheld intermediary processing device, a smart home device, a gaming console, and/or a smart appliance). Each of the plurality of devices are communicatively coupled to one another (e.g., via a Bluetooth connection and/or a WiFi connection). Each of the plurality of devices are within a proximity of the user 101 (e.g., worn by the user 101, on the person of the user 101, within seven feet of the user 101, etc.). In some embodiments, the plurality of devices includes an artificially intelligent (AI) assistant operating at one or more of the plurality of devices. In some embodiments, each of the plurality of devices includes a respective AI assistant. The AI assistant is configured to provide one or responses in response to one or more commands from the user 101. In some embodiments, the AI assistant presents one or more visual responses at one or more displays of the plurality of devices, and/or the AI assistant presents one or more audio responses at one or more speakers of the plurality of devices.

The AI assistant is configured to receive the one or more commands from the user 101 and, based on the one or more commands, generate the one or more responses and/or perform one or more tasks, in accordance with some embodiments. The one or more commands include voice commands (e.g., detected at one or more microphones of the plurality of devices), in-air hand gestures (e.g., detected at one or more inertial measurement unit (IMU) sensors of the plurality of devices and/or at one or more imaging devices of the plurality of devices), a touch-input (e.g., detected at one or more touch-input surfaces of the plurality of devices), and/or an eye-movement gesture (e.g., detected at one or more eye-tracking devices of the plurality of devices) performed by the user 101. In some embodiments, the AI assistant is invoked in response to a determination that a voice command 111 (e.g., “Assistant, can you get me to the library?”, as illustrated in FIG. 1), performed by the user 101, includes one or more wake words (e.g., “Assistant,” as illustrated in FIG. 1, “Hey Assistant,” “Look and tell me what I see,” etc.). In some embodiments, the AI assistant is invoked in response to a determination that the voice command 111 is directed at the AI assistant, based on one more contextual elements (e.g., contents of the voice command 111, previous voice commands, whether the user 101 is talking with another person, whether the user 101 is interacting with one or more of the plurality of devices, location data, and/or user settings). In response to the AI assistant being invoked, the AI assistant determines the one or more tasks (e.g., determine a route to a nearest library, as illustrated in FIG. 1) to be performed based on the voice command 111, and the AI assistant performs the one or more tasks. In some embodiments, the AI assistant provides the one or more responses based on the voice command 111 (e.g., “Ok, let's go to the library,” as illustrated in FIG. 1, and/or “Ok, finding a route to the library”), and/or the AI assistant provides the one or more responses based on the one or more tasks (e.g., “Take a left at the next street.” and/or a map of a route to the library, as illustrated in FIG. 1).

As an example, FIG. 1 illustrates user 101 performs the voice command 111 (e.g., “Assistant, can you get me to the library”). The AI assistant detects the voice command 111, including the wake work (e.g., “Assistant”), at the one or more microphones of the plurality of devices. Based on the voice command 111, the AI assistant determines the one or more tasks (e.g., determine a route to a nearest library) and presents the one or more responses based on the voice command 111 and/or the one or more tasks at the head-wearable device 110, the wrist-wearable device 115, and/or the one or more other devices (e.g., the smartphone 117). The one or more responses includes one or more of: (i) a visual response presented at a display of the head-wearable device 110, (ii) an audio response 120 presented at a speaker of the head-wearable device 110 (e.g., “Ok, let's go to the library. Take a left at the next street.”), (iii) a visual response 125 presented at a display of the wrist-wearable device 115 (e.g., a map of a route to the library), (iv) an audio response presented at a speaker of the head-wearable device 110, (v) a visual response 127 presented at a display of the one or more other devices (e.g., a map of a route to the library), (vi) an audio response presented at a speaker of the one or more other devices. In some embodiments, the AI assistant receives the voice command 111 at a first device of the plurality of devices (e.g., the head-wearable device 110) and presents the one or more responses based on the voice command 111 and/or the one or more tasks at a second device of the plurality of devices (e.g., the wrist-wearable device 115).

In some embodiments, the AI assistant receives the voice command 111 at and/or presents the one or more responses at one of the plurality of devices based on respective device states of each of the plurality of devices. The head-wearable device 110 may be in at least one of a plurality of head-wearable device states including: (i) a head-wearable device on state (e.g., the head-wearable device 110 is being worn by the user 101), (ii) a head-wearable device off state (e.g., the head-wearable device 110 is not being worn by the user 101), (iii) a head-wearable device closed state (e.g., temple arms of the head-wearable device 110 are in a folded position), (iv) a head-wearable device low-battery state (e.g., a battery level of the head-wearable device 110 is below a head-wearable device battery threshold), and/or (v) a head-wearable device charging state (e.g., a battery the head-wearable device 110 is currently being recharged). The wrist-wearable device 115 may be in at least one of a plurality of wrist-wearable device states including: (i) a wrist-wearable device on state (e.g., the wrist-wearable device 115 is being worn by the user 101), (ii) a wrist-wearable device off state (e.g., the wrist-wearable device 115 is not being worn by the user 101), (iii) a wrist-wearable device low-battery state (e.g., a battery level of the wrist-wearable device 115 below a wrist-wearable device battery threshold), and/or (iv) a wrist-wearable device charging state (e.g., a battery of the wrist-wearable device 115 is currently being recharged). The one or more other devices (e.g., the smartphone 117) may be in at least one of a plurality of other device states including: (i) an other device proximity state (e.g., the one or more other devices is within the proximity of the user 101), (ii) an other device low-battery state (e.g., a battery level of the one or more other devices is below an other device battery threshold), and/or (iii) an other device charging state (e.g., a battery of the one or more other devices is currently being recharged). In some embodiments, the AI assistant receives the voice command 111 at and/or presents the one or more responses at one of the plurality of devices based on one or more user settings determined by the user 101 (e.g., a user setting includes a preference to receive/present at the head-wearable device 110).

As an example, if the head-wearable device 110 is in the head-wearable device on state, the AI assistant will receive the voice command 111 at and/or present the one or more responses at the head-wearable device 110, regardless of a respective state of the wrist-wearable device 115 and a respective state of the one or more other devices. If the head-wearable device 110 is in a state other the head-wearable device on state (e.g., the head-wearable device off state), and the wrist-wearable device 115 is in the wrist-wearable device on state, the AI assistant will receive the voice command 111 at and/or present the one or more responses at the wrist-wearable device 115, regardless of the respective state of the one or more other devices. If the head-wearable device 110 is in a state other the head-wearable device on state (e.g., the head-wearable device off state), the wrist-wearable device 115 is in a state other than the wrist-wearable device on state (e.g., the wrist-wearable device off state), and one or more other devices is in the other device proximity state, the AI assistant will receive the voice command 111 at and/or present the one or more responses at the one or more other devices.

As another example, the user 101 performs the voice command 111 while wearing the head-wearable device 110 and the wrist-wearable device 115. The AI assistant receives the voice command 111 at and presents the one or more responses at the head-wearable device 110, in accordance with a determination that the head-wearable device 110 is in the head-wearable device on state. The user 101 then removes the head-wearable device 110 from their head and performs a second voice command. The AI assistant receives the second voice command at and presents one or more second responses at the wrist-wearable device 115, in accordance with a determination that the head-wearable device 110 is in a state other than the head-wearable device on state and a determination that the wrist-wearable device 115 is in the wrist-wearable device on state.

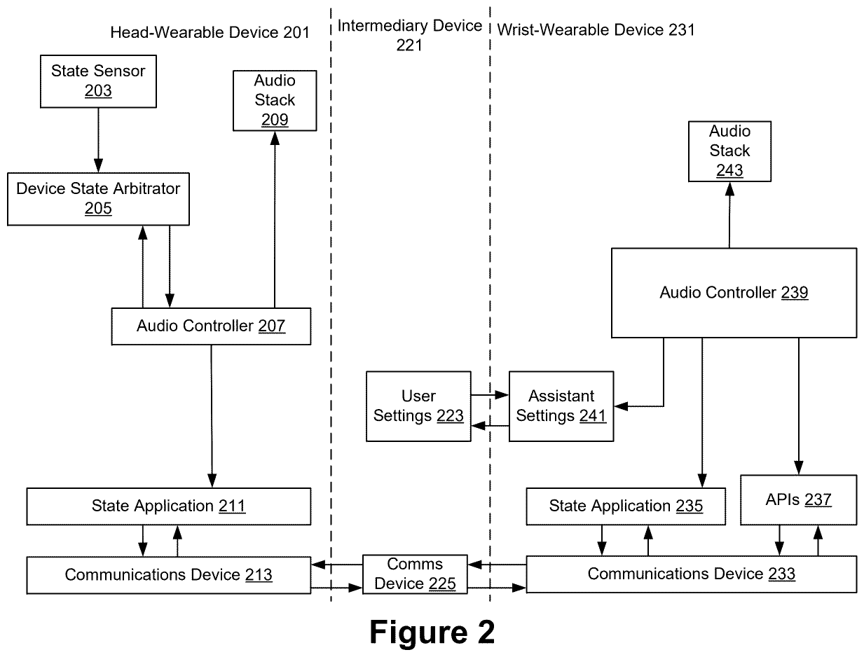

FIG. 2 illustrates an example system diagram for a head-wearable device 201 (e.g., the head-wearable device 110) indicating, to a wrist-wearable device 231 (e.g., the wrist-wearable device 115), a current state of the head-wearable device 201, in accordance with some embodiments. A state sensor 203 of the head-wearable device 203 (e.g., a contact sensor that provides data indicating whether the user 101 is wearing the head-wearable device 203, a hinge sensor that provides data indicating whether temple arms of the head-wearable device 201 are in a folded position, and/or a battery-level sensor that provides data indicating a battery level of the head-wearable device 201) sends state indication data to a device state arbitrator 205. The device state arbitrator 205 determines, based on the state indication data, whether the head-wearable device 201 is in the head-wearable device on state. In accordance with a determination that the head-wearable device 201 is in the head-wearable device on state, the device state arbitrator 205 sends, to an audio controller 207 of the head-wearable device 201, an indication that the head-wearable device 201 is in the head-wearable device on state. In accordance with a determination that the head-wearable device 201 is in a state other than the head-wearable device on state, the device state arbitrator 205 sends, to the audio controller 207, an indication that the head-wearable device 201 is not in the head-wearable device on state. In response to receiving the indication that the head-wearable device 201 is in the head-wearable device on state, the audio controller 207 sends, to an audio stack 209 of the head-wearable device 201, an instruction to listen for a wake word at a microphone of the head-wearable device 201 and sends, to a state application 211 executed at the head-wearable device 201, an indication that the head-wearable device 201 is listening for the wake word. In response to receiving the indication that the head-wearable device 201 is not in the head-wearable device on state, the audio controller 207 sends, to the audio stack 209, an instruction to not listen for the wake word at the microphone of the head-wearable device 201 and sends, to the state application 211 executed at the head-wearable device 201, an indication that the head-wearable device 201 is not listening for the wake word.

The state application 211 executed at the head-wearable device 201 transmits the indication that the head-wearable device 201 is listening for the wake word and/or the indication that the head-wearable device 201 is not listening for the wake word from a communications device 213 of the head-wearable device 201 to a communications device 233 of the wrist-wearable device 231. In some embodiments, the indication that the head-wearable device 201 is listening for the wake word and/or the indication that the head-wearable device 201 is not listening for the wake word from the communications device 213 to the communications device 233 via a communications device 225 of an intermediary device 221 (e.g., the smartphone 117, a handheld intermediary processing device, a personal computer, etc.). The communications device 233 relays the indication that the head-wearable device 201 is listening for the wake word and/or the indication that the head-wearable device 201 is not listening for the wake word to a state application 235 executed at the wrist-wearable device 231 and/or one or more application programming interfaces (APIs) 237.

An audio controller 239 of the wrist-wearable device 231 reads, from the state application 235 and/or the one or more APIs 237, the indication that the head-wearable device 201 is listening for the wake word and/or the indication that the head-wearable device 201 is not listening for the wake word. In some embodiments, the audio controller 239 reads, from AI assistant settings 241, a user preference setting indicating a user's preferred device for interacting with the AI assistant. In some embodiments, the AI assistant settings 241 reads the user preference setting from a set of user settings 223 stored at the intermediary device 221. In accordance with reading the indication that the head-wearable device 201 is listening for the wake word and the user preference setting indicating that the user 101 prefers the head-wearable device 201 for interacting with the AI assistant, the audio controller 239 sends, to an audio stack 243 of the wrist-wearable device 231, an instruction to not listen for the wake word at a microphone of the wrist-wearable device 231. In accordance with reading the indication that the head-wearable device 201 is not listening for the wake word, the audio controller 239 sends, to the audio stack 243, an instruction to listen for the wake word at the microphone of the wrist-wearable device 231. In some embodiments, in accordance with the user preference setting indicating that the user 101 prefers the wrist-wearable device 231 for interacting with the AI assistant, the audio controller 239 sends, to the audio stack 243, the instruction to listen for the wake word at the microphone of the wrist-wearable device 231 and, to the head-wearable device 201, an indication that the user 101 prefers the wrist-wearable device 231 for interacting with the AI assistant and the wrist-wearable device 231 is listening for the wake word. In some embodiments, the coordination of which device of the head-wearable device 201 and the wrist-wearable device 221 is performed by a state application executed at one or more processors of the head-wearable device 201 (e.g., the state application 211), the wrist-wearable device 231 (e.g., the state application 235), and/or the intermediary device 221.

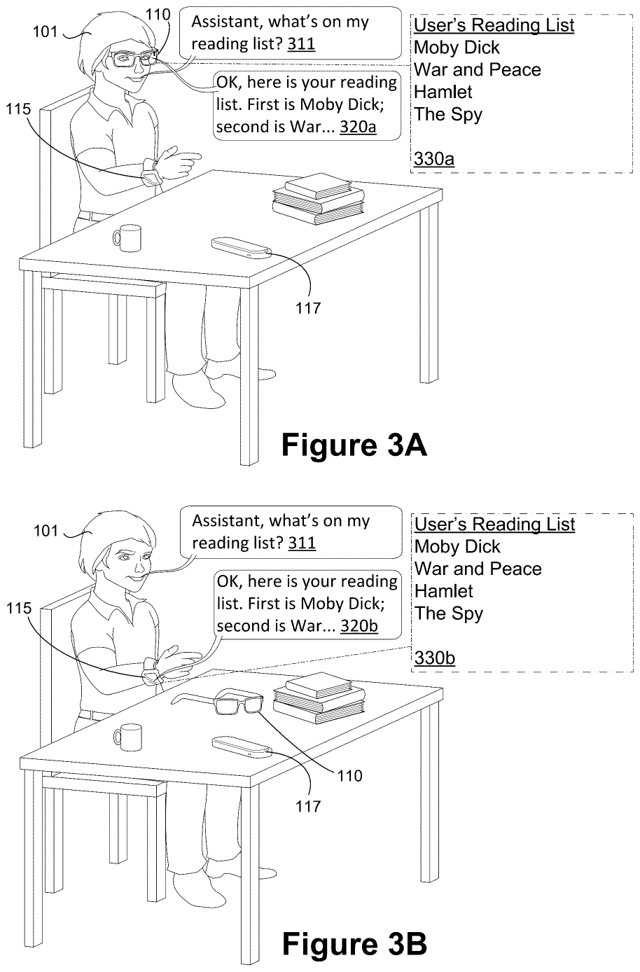

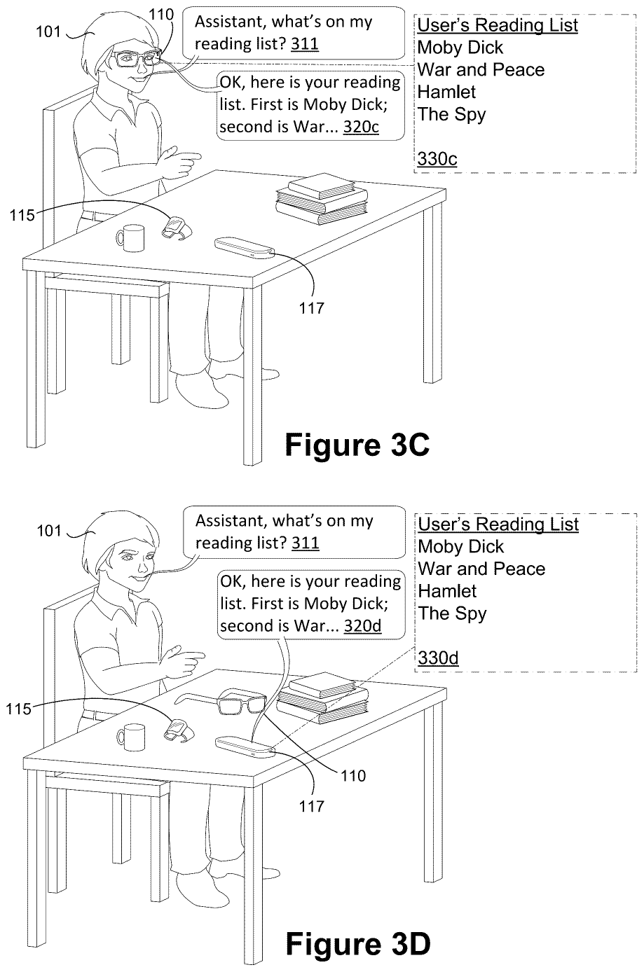

FIGS. 3A-3D illustrate the user 101 interacting with the AI assistant at the head-wearable device 110, the wrist-wearable device 115, and the one or more other devices (e.g., the smartphone 117), based on the respective states of the plurality of devices, in accordance with some embodiments. FIG. 3A illustrates the user 101 interacting with the AI assistant while wearing the head-wearable device 110 and the wrist-wearable device 115, in accordance with some embodiments. In accordance with a determination that a user setting indicates that a user's preferred device for interacting with the AI assistant is the head-wearable device 110 and a determination that the head-wearable device 110 is in the head-wearable device on state, the AI assistant listens for the wake word at the head-wearable device 110. The user 101 performs a first command 311 (e.g., “Assistant, what's on my reading list?”) including the wake word (e.g., “Assistant”). In response to detecting the first command 311, the AI assistant determines one or more tasks (e.g., present the user's reading list) based on the on the first command 311. After the AI assistant determines and/or executes the one or more tasks, the AI assistant presents an audio response 320a (e.g., “OK, here is your reading list. First is Moby Dick; second is War . . . ”) at the speaker of the head-wearable device 110 and/or a visual response 330a (e.g., the user's reading list) at the display of the head-wearable device 110.

In some embodiments, in accordance with a determination that the user setting indicates that the user's preferred device for interacting with the AI assistant is the wrist-wearable device 115 and a determination that the wrist-wearable device 115 is in the wrist-wearable device on state, the AI assistant listens for the wake word at the wrist-wearable device 115. The user 101 performs the first command 311 including the wake word. In response to detecting the first command 311, the AI assistant determines the one or more tasks based on the on the first command 311. After the AI assistant determines and/or executes the one or more tasks, the AI assistant presents another audio response at the speaker of the wrist-wearable device 115 and/or another visual response at the display of the wrist-wearable device 115.

FIG. 3B illustrates the user 101 interacting with the AI assistant while not wearing the head-wearable device 110 and wearing the wrist-wearable device 115, in accordance with some embodiments. In accordance with a determination that the head-wearable device 110 is in the head-wearable device off state and a determination that the wrist-wearable device 115 is in the wrist-wearable device on state, the AI assistant listens for the wake word at the wrist-wearable device 115. The user 101 performs the first command 311 including the wake word. In response to detecting the first command 311, the AI assistant determines the one or more tasks based on the on the first command 311. After the AI assistant determines and/or executes the one or more tasks, the AI assistant presents an audio response 320b at the speaker of the wrist-wearable device 115 and/or a visual response 330b at the display of the wrist-wearable device 115.

FIG. 3C illustrates the user 101 interacting with the AI assistant while wearing the head-wearable device 110 and not wearing the wrist-wearable device 115, in accordance with some embodiments. In accordance with a determination that the head-wearable device 110 is in the head-wearable device on state and a determination that the wrist-wearable device 115 is in the wrist-wearable device off state, the AI assistant listens for the wake word at the head-wearable device 110. The user 101 performs the first command 311 including the wake word. In response to detecting the first command 311, the AI assistant determines the one or more tasks based on the on the first command 311. After the AI assistant determines and/or executes the one or more tasks, the AI assistant presents an audio response 320c at the speaker of the head-wearable device 110 and/or a visual response 330c at the display of the head-wearable device 110.

FIG. 3D illustrates the user 101 interacting with the AI assistant while not wearing the head-wearable device 110 and not wearing the wrist-wearable device 115, in accordance with some embodiments. In accordance with a determination that the head-wearable device 110 is in the head-wearable device off state and a determination that the wrist-wearable device 115 is in the wrist-wearable device off state, the AI assistant listens for the wake word at the one or more other devices (e.g., the smartphone 117). The user 101 performs the first command 311 including the wake word. In response to detecting the first command 311, the AI assistant determines the one or more tasks based on the on the first command 311. After the AI assistant determines and/or executes the one or more tasks, the AI assistant presents an audio response 320d at a speaker of the one or more other devices (e.g., a speaker of the smartphone 117) and/or a visual response 330d at a display of the one or more other devices (e.g., a display of the smartphone 117).

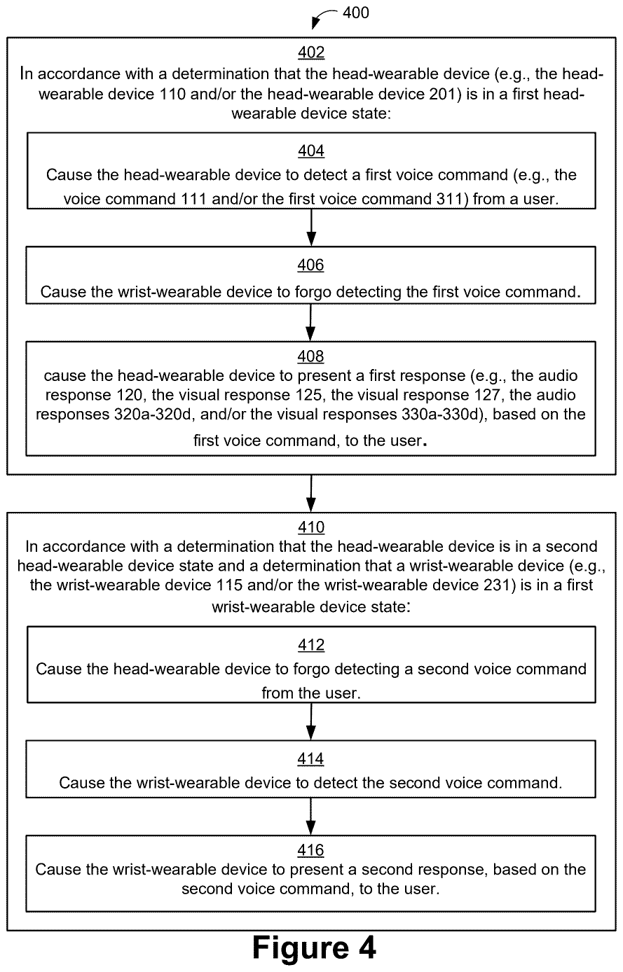

FIG. 4 illustrates a flow diagram of a method for arbitrating wake word detection at a plurality of devices, in accordance with some embodiments. Operations (e.g., steps) of the method 400 can be performed by one or more processors (e.g., central processing unit and/or MCU) of a system including one or more head-wearable devices, one or more wrist-wearable devices, and/or one or more other devices. At least some of the operations shown in FIG. 4 correspond to instructions stored in a computer memory or computer-readable storage medium (e.g., storage, RAM, and/or memory) of the one or more head-wearable devices, the one or more wrist-wearable devices, and/or the one or more other devices. Operations of the method 400 can be performed by a single device alone or in conjunction with one or more processors and/or hardware components of another communicatively coupled device (e.g., one or more head-wearable devices, one or more wrist-wearable devices, and/or one or more other devices) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.
(A1) FIG. 4 shows a flow chart of a method 400 of arbitrating wake word detection at a plurality of devices, in accordance with some embodiments.

The method 400 occurs at a head-wearable device (e.g., the head-wearable device 110 and/or the head-wearable device 201), a wrist-wearable device (e.g., the wrist-wearable device 115 and/or the wrist-wearable device 231), and/or another device (e.g., the one or more other devices, such as the smartphone 117 and/or the intermediary device 221) with one or more displays speakers, one or more microphones, and/or one or more non-transitory, computer-readable storage media including executable instructions. In some embodiments, the method 400 is executed at the non-transitory, computer-readable storage medium while the head-wearable device is communicatively coupled to the wrist-wearable device. The method 400 includes, in accordance with a determination that the head-wearable device is in a first head-wearable device state (e.g., the head-wearable device 110 is worn by the user 101) (402): (i) causing the head-wearable device to detect a first voice command (e.g., the voice command 111 and/or the first voice command 311) from a user (e.g., the user 101) (404), (ii) causing the wrist-wearable device to forgo detecting the first voice command (406) (e.g., a microphone of the wrist-wearable device is caused to no longer listen for and/or otherwise process any detected any audio indicative of the first voice command), and (iii) causing the head-wearable device to present a first response (e.g., the audio response 120, the visual response 125, the visual response 127, the audio responses 320a-320d, and/or the visual responses 330a-330d), based on the first voice command, to the user (408). The method 400 further includes, in accordance with a determination that the head-wearable device is in a second head-wearable device state (e.g., the head-wearable device 110 is not worn by the user 101) and a determination that the wrist-wearable device is in a first wrist-wearable device state (e.g., the wrist-wearable device 115 is worn by the user 101) (410): (i) causing the head-wearable device to forgo detecting a second voice command from the user (412) ) (e.g., a microphone of the head-wearable device is caused to no longer listen for and/or otherwise process any detected any audio indicative of the first voice command), (ii) causing the wrist-wearable device to detect the second voice command (414), and (iii) causing the wrist-wearable device to present a second response, based on the second voice command, to the user (416).
(A2) In some embodiments of A2, (i) the determination that the head-wearable device is in the first head-wearable device state includes determining that the head-wearable device is being worn by the user, (ii) the determination that the head-wearable device is in the second head-wearable device state includes determining that the head-wearable device is not being worn by the user, and (iii) the determination that the wrist-wearable device is in the first wrist-wearable device state includes determining that the wrist-wearable device is being worn by the user.
(A3) In some embodiments of any of A1-A2, the method further includes, in accordance with the determination that the head-wearable device is in the second head-wearable device state and a determination that the wrist-wearable device is in a second wrist-wearable device state (e.g., the wrist-wearable device 115 is not worn by the user 101), (i) causing the head-wearable device to forgo detecting a third voice command from the user, (ii) causing the wrist-wearable device to forgo detecting the third voice command, (iii) causing another device to detect the third voice command, and (iv) causing the other device to present a third response, based on the third voice command, to the user. The other device is communicatively coupled to at least one of the head-wearable device and the wrist-wearable device.
(A4) In some embodiments of any of A1-A3, the determination that the wrist-wearable device is in the second wrist-wearable device state includes determining that the wrist-wearable device is not being worn by the user.
(A5) In some embodiments of any of A1-A4, the method 400 further includes, in accordance with a determination that the user prefers the head-wearable to present responses (e.g., via a user setting), (i) causing the head-wearable device to detect a fourth voice command from the user, (ii) causing the wrist-wearable device to forgo detecting the fourth voice command, and (iii) causing the head-wearable device to present a fourth response, based on the fourth voice command, to the user. The method 400 further includes, in accordance with a determination that the user prefers the wrist-wearable to present responses, (i) causing the head-wearable device to forgo detecting the fourth voice command from the user, (ii) causing the wrist-wearable device to detect the fourth voice command, and (iii) causing the wrist-wearable device to present the fourth response, based on the fourth voice command, to the user.
(A6) In some embodiments of any of A1-A5, the determination that the user prefers the head-wearable to present responses and the determination that the user prefers the wrist-wearable to present responses are based on a user setting provided by the user.
(A7) In some embodiments of any of A1-A6, the method 400 further includes, in accordance with the determination that the head-wearable device is in the first head-wearable device state, causing the head-wearable device to provide an indication to the wrist-wearable device that the head-wearable device is in the first head-wearable device state (e.g., as described in reference to FIG. 2). The method 400 further includes, in accordance with the determination that the head-wearable device is in the second head-wearable device state, causing the head-wearable device to provide an indication to the wrist-wearable device that the head-wearable device is in the second head-wearable device state (e.g., as described in reference to FIG. 2).
(A8) In some embodiments of any of A1-A7, the method 400 further includes, in accordance with the determination that the head-wearable device is in the first head-wearable device state, and in response to the head-wearable device detecting the first voice command, causing an artificially intelligent (AI) assistant to be invoked at the head-wearable device (e.g., as described in reference to FIGS. 1, 3A, and 3C). The method 400 further includes, in accordance with the determination that the head-wearable device is in the second head-wearable device state and the determination that the wrist-wearable device is in the first wrist-wearable device state, and in response to the wrist-wearable device detecting the second voice command, cause the AI assistant to be invoked at the wrist-wearable device (e.g., as described in reference to FIGS. 1 and 3B).
(A9) In some embodiments of any of A1-A8, the first response is generated by the AI assistant at the head-wearable device, and the second response is generated by the AI assistant at the wrist-wearable device.
(A10) In some embodiments of any of A1-A9, the method 400 further includes, in accordance with the determination that the head-wearable device is in the first head-wearable device state, and in response to the AI assistant being invoked at the head-wearable device, cause the AI assistant to perform one or more first tasks at the head-wearable device. The method 400 further includes, in accordance with the determination that the head-wearable device is in the second head-wearable device state and the determination that the wrist-wearable device is in the first wrist-wearable device state, and in response to the AI assistant being invoked at the wrist-wearable device, cause the AI assistant to perform one or more second tasks at the wrist-wearable device.
(A11) In some embodiments of any of A1-A10, the first response is based on the one or more first tasks performed by the AI assistant at the head-wearable device, and the second response is based on the one or more second tasks performed by the AI assistant at the wrist-wearable device.
(A12) In some embodiments of any of A1-A11, the head-wearable device is a pair of smart glasses, and the wrist-wearable device is a smartwatch.
(B1) In accordance with some embodiments, a system that includes one or more wrist wearable devices and a pair of augmented-reality glasses, and the system is configured to perform operations corresponding to any of A1-A12.
(C1) In accordance with some embodiments, means configured to perform operations corresponding to any of A1-A12.
(D1) In accordance with some embodiments, a non-transitory computer readable storage medium including instructions that, when executed by a computing device in communication with a pair of augmented-reality glasses, cause the computer device to perform operations corresponding to any of A1-A12.
(E1) In accordance with some embodiments, a method of operating a pair of augmented-reality glasses, including operations that correspond to any of A1-A12.

### Example Extended-Reality Systems

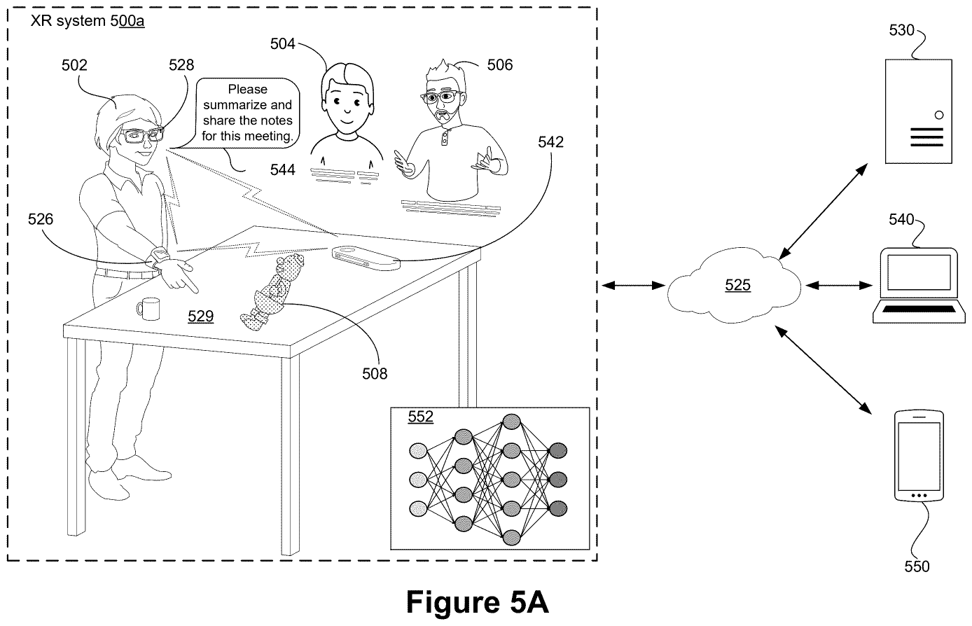

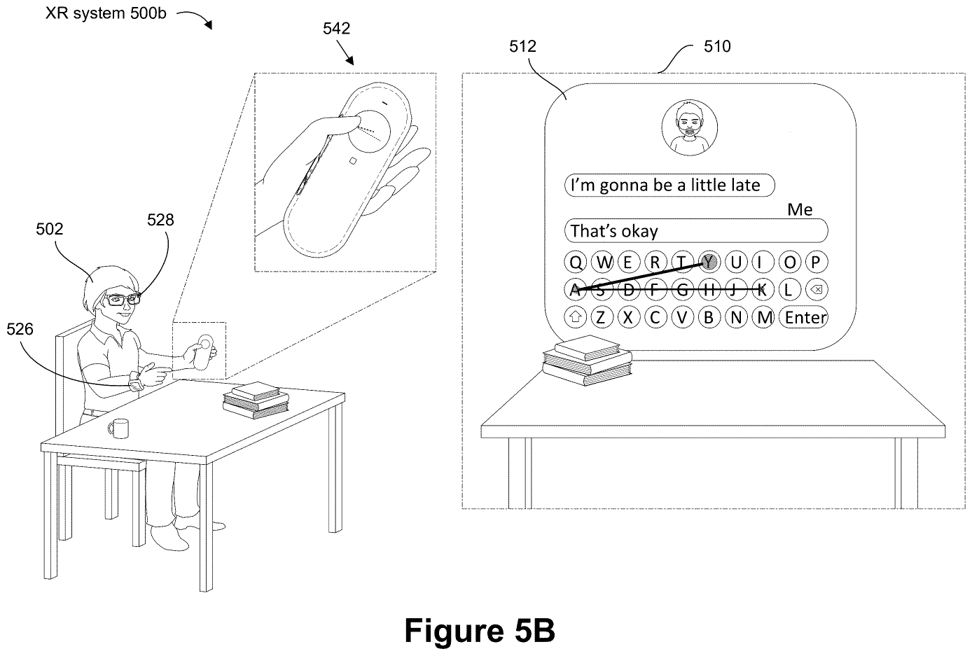

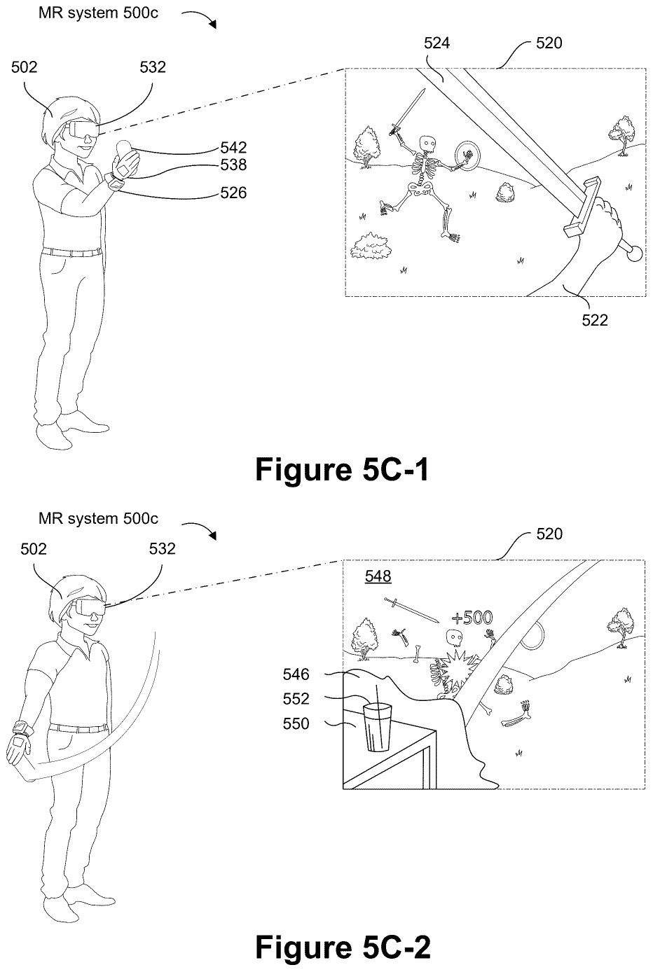

FIGS. 5A, 5B, 5C-1, and 5C-2, illustrate example XR systems that include AR and MR systems, in accordance with some embodiments. FIG. 5A shows a first XR system 500a and first example user interactions using a wrist-wearable device 526, a head-wearable device (e.g., AR device 528), and/or a HIPD 542. FIG. 5B shows a second XR system 500b and second example user interactions using a wrist-wearable device 526, AR device 528, and/or an HIPD 542. FIGS. 5C-1 and 5C-2 show a third MR system 500c and third example user interactions using a wrist-wearable device 526, a head-wearable device (e.g., an MR device such as a VR device), and/or an HIPD 542. As the skilled artisan will appreciate upon reading the descriptions provided herein, the above-example AR and MR systems (described in detail below) can perform various functions and/or operations.

The wrist-wearable device 526, the head-wearable devices, and/or the HIPD 542 can communicatively couple via a network 525 (e.g., cellular, near field, Wi-Fi, personal area network, wireless LAN). Additionally, the wrist-wearable device 526, the head-wearable device, and/or the HIPD 542 can also communicatively couple with one or more servers 530, computers 540 (e.g., laptops, computers), mobile devices 550 (e.g., smartphones, tablets), and/or other electronic devices via the network 525 (e.g., cellular, near field, Wi-Fi, personal area network, wireless LAN). Similarly, a smart textile-based garment, when used, can also communicatively couple with the wrist-wearable device 526, the head-wearable device(s), the HIPD 542, the one or more servers 530, the computers 540, the mobile devices 550, and/or other electronic devices via the network 525 to provide inputs.

Turning to FIG. 5A, a user 502 is shown wearing the wrist-wearable device 526 and the AR device 528 and having the HIPD 542 on their desk. The wrist-wearable device 526, the AR device 528, and the HIPD 542 facilitate user interaction with an AR environment. In particular, as shown by the first AR system 500a, the wrist-wearable device 526, the AR device 528, and/or the HIPD 542 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 526, the AR device 528, and/or the HIPD 542. In addition, the user 502 is also able to directly view physical objects in the environment, such as a physical table 529, through transparent lens(es) and waveguide(s) of the AR device 528. Alternatively, an MR device could be used in place of the AR device 528 and a similar user experience can take place, but the user would not be directly viewing physical objects in the environment, such as table 529, and would instead be presented with a virtual reconstruction of the table 529 produced from one or more sensors of the MR device (e.g., an outward facing camera capable of recording the surrounding environment).

The user 502 can use any of the wrist-wearable device 526, the AR device 528 (e.g., through physical inputs at the AR device and/or built-in motion tracking of a user's extremities), a smart-textile garment, externally mounted extremity tracking device, the HIPD 542 to provide user inputs, etc. For example, the user 502 can perform one or more hand gestures that are detected by the wrist-wearable device 526 (e.g., using one or more EMG sensors and/or IMUs built into the wrist-wearable device) and/or AR device 528 (e.g., using one or more image sensors or cameras) to provide a user input. Alternatively, or additionally, the user 502 can provide a user input via one or more touch surfaces of the wrist-wearable device 526, the AR device 528, and/or the HIPD 542, and/or voice commands captured by a microphone of the wrist-wearable device 526, the AR device 528, and/or the HIPD 542. The wrist-wearable device 526, the AR device 528, and/or the HIPD 542 include an artificially intelligent digital assistant to help the user in providing a user input (e.g., completing a sequence of operations, suggesting different operations or commands, providing reminders, confirming a command). For example, the digital assistant can be invoked through an input occurring at the AR device 528 (e.g., via an input at a temple arm of the AR device 528). In some embodiments, the user 502 can provide a user input via one or more facial gestures and/or facial expressions. For example, cameras of the wrist-wearable device 526, the AR device 528, and/or the HIPD 542 can track the user 502's eyes for navigating a user interface.

The wrist-wearable device 526, the AR device 528, and/or the HIPD 542 can operate alone or in conjunction to allow the user 502 to interact with the AR environment. In some embodiments, the HIPD 542 is configured to operate as a central hub or control center for the wrist-wearable device 526, the AR device 528, and/or another communicatively coupled device. For example, the user 502 can provide an input to interact with the AR environment at any of the wrist-wearable device 526, the AR device 528, and/or the HIPD 542, and the HIPD 542 can identify one or more back-end and front-end tasks to cause the performance of the requested interaction and distribute instructions to cause the performance of the one or more back-end and front-end tasks at the wrist-wearable device 526, the AR device 528, and/or the HIPD 542. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 542 can perform the back-end tasks and provide the wrist-wearable device 526 and/or the AR device 528 operational data corresponding to the performed back-end tasks such that the wrist-wearable device 526 and/or the AR device 528 can perform the front-end tasks. In this way, the HIPD 542, which has more computational resources and greater thermal headroom than the wrist-wearable device 526 and/or the AR device 528, performs computationally intensive tasks and reduces the computer resource utilization and/or power usage of the wrist-wearable device 526 and/or the AR device 528.

In the example shown by the first AR system 500a, the HIPD 542 identifies one or more back-end tasks and front-end tasks associated with a user request to initiate an AR video call with one or more other users (represented by the avatar 504 and the digital representation of the contact 506) and distributes instructions to cause the performance of the one or more back-end tasks and front-end tasks. In particular, the HIPD 542 performs back-end tasks for processing and/or rendering image data (and other data) associated with the AR video call and provides operational data associated with the performed back-end tasks to the AR device 528 such that the AR device 528 performs front-end tasks for presenting the AR video call (e.g., presenting the avatar 504 and the digital representation of the contact 506).

In some embodiments, the HIPD 542 can operate as a focal or anchor point for causing the presentation of information. This allows the user 502 to be generally aware of where information is presented. For example, as shown in the first AR system 500a, the avatar 504 and the digital representation of the contact 506 are presented above the HIPD 542. In particular, the HIPD 542 and the AR device 528 operate in conjunction to determine a location for presenting the avatar 504 and the digital representation of the contact 506. In some embodiments, information can be presented within a predetermined distance from the HIPD 542 (e.g., within five meters). For example, as shown in the first AR system 500a, virtual object 508 is presented on the desk some distance from the HIPD 542. Similar to the above example, the HIPD 542 and the AR device 528 can operate in conjunction to determine a location for presenting the virtual object 508. Alternatively, in some embodiments, presentation of information is not bound by the HIPD 542. More specifically, the avatar 504, the digital representation of the contact 506, and the virtual object 508 do not have to be presented within a predetermined distance of the HIPD 542. While an AR device 528 is described working with an HIPD, an MR headset can be interacted with in the same way as the AR device 528.

User inputs provided at the wrist-wearable device 526, the AR device 528, and/or the HIPD 542 are coordinated such that the user can use any device to initiate, continue, and/or complete an operation. For example, the user 502 can provide a user input to the AR device 528 to cause the AR device 528 to present the virtual object 508 and, while the virtual object 508 is presented by the AR device 528, the user 502 can provide one or more hand gestures via the wrist-wearable device 526 to interact and/or manipulate the virtual object 508. While an AR device 528 is described working with a wrist-wearable device 526, an MR headset can be interacted with in the same way as the AR device 528.

### Integration of Artificial Intelligence With XR Systems

FIG. 5A illustrates an interaction in which an artificially intelligent virtual assistant can assist in requests made by a user 502. The AI virtual assistant can be used to complete open-ended requests made through natural language inputs by a user 502. For example, in FIG. 5A the user 502 makes an audible request 544 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 5A also illustrates an example neural network 552 used in Artificial Intelligence applications. Uses of Artificial Intelligence (AI) are varied and encompass many different aspects of the devices and systems described herein. AI capabilities cover a diverse range of applications and deepen interactions between the user 502 and user devices (e.g., the AR device 528, an MR device 532, the HIPD 542, the wrist-wearable device 526). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 502 can interact with an AI model through natural language inputs captured by a voice sensor, text inputs, or any other input modality that accepts natural language and/or a corresponding voice sensor module. In another instance, input is provided by tracking the eye gaze of a user 502 via a gaze tracker module. Additionally, the AI model can also receive inputs beyond those supplied by a user 502. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 528) or from multiple devices that are in communication with each other (e.g., a system that includes at least two of an AR device 528, an MR device 532, the HIPD 542, the wrist-wearable device 526, etc.). The AI model can also access additional information (e.g., one or more servers 530, the computers 540, the mobile devices 550, and/or other electronic devices) via a network 525.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 528, an MR device 532, the HIPD 542, the wrist-wearable device 526) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 528, an MR device 532, the HIPD 542, the wrist-wearable device 526), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 542), haptic feedback can provide information to the user 502. An AI model can also use the inputs described above to determine the appropriate modality and device(s) to present content to the user (e.g., a user walking on a busy road can be presented with an audio output instead of a visual output to avoid distracting the user 502).

### Example Augmented Reality Interaction

FIG. 5B shows the user 502 wearing the wrist-wearable device 526 and the AR device 528 and holding the HIPD 542. In the second AR system 500b, the wrist-wearable device 526, the AR device 528, and/or the HIPD 542 are used to receive and/or provide one or more messages to a contact of the user 502. In particular, the wrist-wearable device 526, the AR device 528, and/or the HIPD 542 detect and coordinate one or more user inputs to initiate a messaging application and prepare a response to a received message via the messaging application.

In some embodiments, the user 502 initiates, via a user input, an application on the wrist-wearable device 526, the AR device 528, and/or the HIPD 542 that causes the application to initiate on at least one device. For example, in the second AR system 500b the user 502 performs a hand gesture associated with a command for initiating a messaging application (represented by messaging user interface 512); the wrist-wearable device 526 detects the hand gesture; and, based on a determination that the user 502 is wearing the AR device 528, causes the AR device 528 to present a messaging user interface 512 of the messaging application. The AR device 528 can present the messaging user interface 512 to the user 502 via its display (e.g., as shown by user 502's field of view 510). In some embodiments, the application is initiated and can be run on the device (e.g., the wrist-wearable device 526, the AR device 528, and/or the HIPD 542) that detects the user input to initiate the application, and the device provides another device operational data to cause the presentation of the messaging application. For example, the wrist-wearable device 526 can detect the user input to initiate a messaging application, initiate and run the messaging application, and provide operational data to the AR device 528 and/or the HIPD 542 to cause presentation of the messaging application. Alternatively, the application can be initiated and run at a device other than the device that detected the user input. For example, the wrist-wearable device 526 can detect the hand gesture associated with initiating the messaging application and cause the HIPD 542 to run the messaging application and coordinate the presentation of the messaging application.

Further, the user 502 can provide a user input provided at the wrist-wearable device 526, the AR device 528, and/or the HIPD 542 to continue and/or complete an operation initiated at another device. For example, after initiating the messaging application via the wrist-wearable device 526 and while the AR device 528 presents the messaging user interface 512, the user 502 can provide an input at the HIPD 542 to prepare a response (e.g., shown by the swipe gesture performed on the HIPD 542). The user 502's gestures performed on the HIPD 542 can be provided and/or displayed on another device. For example, the user 502's swipe gestures performed on the HIPD 542 are displayed on a virtual keyboard of the messaging user interface 512 displayed by the AR device 528.

In some embodiments, the wrist-wearable device 526, the AR device 528, the HIPD 542, and/or other communicatively coupled devices can present one or more notifications to the user 502. The notification can be an indication of a new message, an incoming call, an application update, a status update, etc. The user 502 can select the notification via the wrist-wearable device 526, the AR device 528, or the HIPD 542 and cause presentation of an application or operation associated with the notification on at least one device. For example, the user 502 can receive a notification that a message was received at the wrist-wearable device 526, the AR device 528, the HIPD 542, and/or other communicatively coupled device and provide a user input at the wrist-wearable device 526, the AR device 528, and/or the HIPD 542 to review the notification, and the device detecting the user input can cause an application associated with the notification to be initiated and/or presented at the wrist-wearable device 526, the AR device 528, and/or the HIPD 542.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 528 can present to the user 502 game application data and the HIPD 542 can use a controller to provide inputs to the game. Similarly, the user 502 can use the wrist-wearable device 526 to initiate a camera of the AR device 528, and the user can use the wrist-wearable device 526, the AR device 528, and/or the HIPD 542 to manipulate the image capture (e.g., zoom in or out, apply filters) and capture image data.

While an AR device 528 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 5C-1 and 5C-2, the user 502 is shown wearing the wrist-wearable device 526 and an MR device 532 (e.g., a device capable of providing either an entirely VR experience or an MR experience that displays object(s) from a physical environment at a display of the device) and holding the HIPD 542. In the third AR system 500c, the wrist-wearable device 526, the MR device 532, and/or the HIPD 542 are used to interact within an MR environment, such as a VR game or other MR/VR application. While the MR device 532 presents a representation of a VR game (e.g., first MR game environment 520) to the user 502, the wrist-wearable device 526, the MR device 532, and/or the HIPD 542 detect and coordinate one or more user inputs to allow the user 502 to interact with the VR game.

In some embodiments, the user 502 can provide a user input via the wrist-wearable device 526, the MR device 532, and/or the HIPD 542 that causes an action in a corresponding MR environment. For example, the user 502 in the third MR system 500c (shown in FIG. 5C-1) raises the HIPD 542 to prepare for a swing in the first MR game environment 520. The MR device 532, responsive to the user 502 raising the HIPD 542, causes the MR representation of the user 522 to perform a similar action (e.g., raise a virtual object, such as a virtual sword 524). In some embodiments, each device uses respective sensor data and/or image data to detect the user input and provide an accurate representation of the user 502's motion. For example, image sensors (e.g., SLAM cameras or other cameras) of the HIPD 542 can be used to detect a position of the HIPD 542 relative to the user 502's body such that the virtual object can be positioned appropriately within the first MR game environment 520; sensor data from the wrist-wearable device 526 can be used to detect a velocity at which the user 502 raises the HIPD 542 such that the MR representation of the user 522 and the virtual sword 524 are synchronized with the user 502's movements; and image sensors of the MR device 532 can be used to represent the user 502's body, boundary conditions, or real-world objects within the first MR game environment 520.

In FIG. 5C-2, the user 502 performs a downward swing while holding the HIPD 542. The user 502's downward swing is detected by the wrist-wearable device 526, the MR device 532, and/or the HIPD 542 and a corresponding action is performed in the first MR game environment 520. In some embodiments, the data captured by each device is used to improve the user's experience within the MR environment. For example, sensor data of the wrist-wearable device 526 can be used to determine a speed and/or force at which the downward swing is performed and image sensors of the HIPD 542 and/or the MR device 532 can be used to determine a location of the swing and how it should be represented in the first MR game environment 520, which, in turn, can be used as inputs for the MR environment (e.g., game mechanics, which can use detected speed, force, locations, and/or aspects of the user 502's actions to classify a user's inputs (e.g., user performs a light strike, hard strike, critical strike, glancing strike, miss) or calculate an output (e.g., amount of damage)).

FIG. 5C-2 further illustrates that a portion of the physical environment is reconstructed and displayed at a display of the MR device 532 while the MR game environment 520 is being displayed. In this instance, a reconstruction of the physical environment 546 is displayed in place of a portion of the MR game environment 520 when object(s) in the physical environment are potentially in the path of the user (e.g., a collision with the user and an object in the physical environment are likely). Thus, this example MR game environment 520 includes (i) an immersive VR portion 548 (e.g., an environment that does not have a corollary counterpart in a nearby physical environment) and (ii) a reconstruction of the physical environment 546 (e.g., table 550 and cup 552). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 526, the MR device 532, and/or the HIPD 542 are described as detecting user inputs, in some embodiments, user inputs are detected at a single device (with the single device being responsible for distributing signals to the other devices for performing the user input). For example, the HIPD 542 can operate an application for generating the first MR game environment 520 and provide the MR device 532 with corresponding data for causing the presentation of the first MR game environment 520, as well as detect the user 502's movements (while holding the HIPD 542) to cause the performance of corresponding actions within the first MR game environment 520. Additionally or alternatively, in some embodiments, operational data (e.g., sensor data, image data, application data, device data, and/or other data) of one or more devices is provided to a single device (e.g., the HIPD 542) to process the operational data and cause respective devices to perform an action associated with processed operational data.

In some embodiments, the user 502 can wear a wrist-wearable device 526, wear an MR device 532, wear smart textile-based garments 538 (e.g., wearable haptic gloves), and/or hold an HIPD 542 device. In this embodiment, the wrist-wearable device 526, the MR device 532, and/or the smart textile-based garments 538 are used to interact within an MR environment (e.g., any AR or MR system described above in reference to FIGS. 5A-5B). While the MR device 532 presents a representation of an MR game (e.g., second MR game environment 520) to the user 502, the wrist-wearable device 526, the MR device 532, and/or the smart textile-based garments 538 detect and coordinate one or more user inputs to allow the user 502 to interact with the MR environment.

In some embodiments, the user 502 can provide a user input via the wrist-wearable device 526, an HIPD 542, the MR device 532, and/or the smart textile-based garments 538 that causes an action in a corresponding MR environment. In some embodiments, each device uses respective sensor data and/or image data to detect the user input and provide an accurate representation of the user 502's motion. While four different input devices are shown (e.g., a wrist-wearable device 526, an MR device 532, an HIPD 542, and a smart textile-based garment 538) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 538) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 538 can be used in conjunction with an MR device and/or an HIPD 542.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 5A-5C-2 provided above are intended to augment the description provided in reference to FIGS. 1-4. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to:
while a head-wearable device is communicatively coupled to a wrist-wearable device:
in accordance with a determination that the head-wearable device is in a first head-wearable device state:
cause the head-wearable device to detect a first voice command from a user;
cause the wrist-wearable device to forgo detecting the first voice command; and
cause the head-wearable device to present a first response, based on the first voice command, to the user; and
in accordance with a determination that the head-wearable device is in a second head-wearable device state and a determination that the wrist-wearable device is in a first wrist-wearable device state:
cause the head-wearable device to forgo detecting a second voice command from the user;
cause the wrist-wearable device to detect the second voice command; and
cause the wrist-wearable device to present a second response, based on the second voice command, to the user.

2. The non-transitory, computer-readable storage medium of claim 1, wherein:
the determination that the head-wearable device is in the first head-wearable device state includes determining that the head-wearable device is being worn by the user;
the determination that the head-wearable device is in the second head-wearable device state includes determining that the head-wearable device is not being worn by the user; and
the determination that the wrist-wearable device is in the first wrist-wearable device state includes determining that the wrist-wearable device is being worn by the user.

3. The non-transitory, computer-readable storage medium of claim 1, wherein the executable instructions further cause the one or more processors to:
while the head-wearable device is communicatively coupled to the wrist-wearable device:
in accordance with the determination that the head-wearable device is in the second head-wearable device state and a determination that the wrist-wearable device is in a second wrist-wearable device state:
cause the head-wearable device to forgo detecting a third voice command from the user;
cause the wrist-wearable device to forgo detecting the third voice command;
cause another device to detect the third voice command; and
cause the other device to present a third response, based on the third voice command, to the user, wherein the other device is communicatively coupled to at least one of the head-wearable device and the wrist-wearable device.

4. The non-transitory, computer-readable storage medium of claim 3, wherein the determination that the wrist-wearable device is in the second wrist-wearable device state includes determining that the wrist-wearable device is not being worn by the user.

5. The non-transitory, computer-readable storage medium of claim 1, wherein the executable instructions further cause the one or more processors to:
while the head-wearable device is communicatively coupled to the wrist-wearable device:
in accordance with the determination that the head-wearable device is in the first head-wearable device state, and the determination that the wrist-wearable device is in the first wrist-wearable device state:
in accordance with a determination that the user prefers the head-wearable to present responses:
cause the head-wearable device to detect a fourth voice command from the user;
cause the wrist-wearable device to forgo detecting the fourth voice command; and
cause the head-wearable device to present a fourth response, based on the fourth voice command, to the user; and
in accordance with a determination that the user prefers the wrist-wearable to present responses:
cause the head-wearable device to forgo detecting the fourth voice command from the user;
cause the wrist-wearable device to detect the fourth voice command; and
cause the wrist-wearable device to present the fourth response, based on the fourth voice command, to the user.

6. The non-transitory, computer-readable storage medium of claim 5, wherein the determination that the user prefers the head-wearable to present responses and the determination that the user prefers the wrist-wearable to present responses are based on a user setting provided by the user.

7. The non-transitory, computer-readable storage medium of claim 1, wherein the executable instructions further cause the one or more processors to:
while the head-wearable device is communicatively coupled to the wrist-wearable device:
in accordance with the determination that the head-wearable device is in the first head-wearable device state:
cause the head-wearable device to provide an indication to the wrist-wearable device that the head-wearable device is in the first head-wearable device state; and
in accordance with the determination that the head-wearable device is in the second head-wearable device state:
cause the head-wearable device to provide an indication to the wrist-wearable device that the head-wearable device is in the second head-wearable device state.

8. The non-transitory, computer-readable storage medium of claim 1, wherein the executable instructions further cause the one or more processors to:
while the head-wearable device is communicatively coupled to the wrist-wearable device:
in accordance with the determination that the head-wearable device is in the first head-wearable device state:
in response to the head-wearable device detecting the first voice command, cause an artificially intelligent (AI) assistant to be invoked at the head-wearable device; and
in accordance with the determination that the head-wearable device is in the second head-wearable device state and the determination that the wrist-wearable device is in the first wrist-wearable device state:
in response to the wrist-wearable device detecting the second voice command, cause the AI assistant to be invoked at the wrist-wearable device.

9. The non-transitory, computer-readable storage medium of claim 8, wherein:
the first response is generated by the AI assistant at the head-wearable device; and
the second response is generated by the AI assistant at the wrist-wearable device.

10. The non-transitory, computer-readable storage medium of claim 8, wherein the executable instructions further cause the one or more processors to:
while the head-wearable device is communicatively coupled to the wrist-wearable device:
in accordance with the determination that the head-wearable device is in the first head-wearable device state:
in response to the AI assistant being invoked at the head-wearable device, cause the AI assistant to perform one or more first tasks at the head-wearable device; and
in accordance with the determination that the head-wearable device is in the second head-wearable device state and the determination that the wrist-wearable device is in the first wrist-wearable device state:
in response to the AI assistant being invoked at the wrist-wearable device, cause the AI assistant to perform one or more second tasks at the wrist-wearable device.

11. The non-transitory, computer-readable storage medium of claim 10, wherein:
the first response is based on the one or more first tasks performed by the AI assistant at the head-wearable device; and
the second response is based on the one or more second tasks performed by the AI assistant at the wrist-wearable device.

12. The non-transitory, computer-readable storage medium of claim 1, wherein:
the head-wearable device is a pair of smart glasses; and
the wrist-wearable device is a smartwatch.

13. A system including:
a head-wearable device including one or more microphones;
a wrist-wearable device, communicatively coupled to the head-wearable device, including one or more other microphones;
one or more processors configured to:
in accordance with a determination that the head-wearable device is in a first head-wearable device state:
cause the head-wearable device to detect a first voice command from a user;
cause the wrist-wearable device to forgo detecting the first voice command; and
cause the head-wearable device to present a first response, based on the first voice command, to the user; and
in accordance with a determination that the head-wearable device is in a second head-wearable device state and a determination that the wrist-wearable device is in a first wrist-wearable device state:
cause the head-wearable device to forgo detecting a second voice command from the user;
cause the wrist-wearable device to detect the second voice command; and
cause the wrist-wearable device to present a second response, based on the second voice command, to the user.

14. The system of claim 13, wherein:
the determination that the head-wearable device is in the first head-wearable device state includes determining that the head-wearable device is being worn by the user;
the determination that the head-wearable device is in the second head-wearable device state includes determining that the head-wearable device is not being worn by the user; and
the determination that the wrist-wearable device is in the first wrist-wearable device state includes determining that the wrist-wearable device is being worn by the user.

15. The system of claim 13, wherein the one or more processors are configured to:
in accordance with the determination that the head-wearable device is in the second head-wearable device state and a determination that the wrist-wearable device is in a second wrist-wearable device state:
cause the head-wearable device to forgo detecting a third voice command from the user;
cause the wrist-wearable device to forgo detecting the third voice command;
cause another device to detect the third voice command; and
cause the other device to present a third response, based on the third voice command, to the user, wherein the other device is communicatively coupled to at least one of the head-wearable device and the wrist-wearable device.

16. The system of claim 13, wherein the one or more processors are configured to:
in accordance with the determination that the head-wearable device is in the first head-wearable device state:
in response to the head-wearable device detecting the first voice command, cause an artificially intelligent (AI) assistant to be invoked at the head-wearable device; and
in accordance with the determination that the head-wearable device is in the second head-wearable device state and the determination that the wrist-wearable device is in the first wrist-wearable device state:
in response to the wrist-wearable device detecting the second voice command, cause the AI assistant to be invoked at the wrist-wearable device.

17. A method comprising:
while a head-wearable device is communicatively coupled to a wrist-wearable device:
in accordance with a determination that the head-wearable device is in a first head-wearable device state:
detecting a first voice command from a user at the head-wearable device;
forgoing detecting the first voice command at the wrist-wearable device; and
presenting a first response, based on the first voice command, to the user at the head-wearable; and
in accordance with a determination that the head-wearable device is in a second head-wearable device state and a determination that the wrist-wearable device is in a first wrist-wearable device state:
forgoing detecting a second voice command from at the user the head-wearable device;
detecting the second voice command at the wrist-wearable device; and
presenting a second response, based on the second voice command, to the user at the wrist-wearable device.

18. The system of claim 13, wherein:
the determination that the head-wearable device is in the first head-wearable device state includes determining that the head-wearable device is being worn by the user;
the determination that the head-wearable device is in the second head-wearable device state includes determining that the head-wearable device is not being worn by the user; and
the determination that the wrist-wearable device is in the first wrist-wearable device state includes determining that the wrist-wearable device is being worn by the user.

19. The system of claim 13, wherein the one or more processors are configured to:
in accordance with the determination that the head-wearable device is in the second head-wearable device state and a determination that the wrist-wearable device is in a second wrist-wearable device state:
forgoing detecting a third voice command from the user at the head-wearable device;
forgoing detecting the third voice command the wrist-wearable device;
detecting the third voice command another device; and
present a third response, based on the third voice command, to the user at the other device, wherein the other device is communicatively coupled to at least one of the head-wearable device and the wrist-wearable device.

20. The system of claim 13, wherein the one or more processors are configured to:
in accordance with the determination that the head-wearable device is in the first head-wearable device state:
in response to the head-wearable device detecting the first voice command, invoking an artificially intelligent (AI) assistant at the head-wearable device; and
in accordance with the determination that the head-wearable device is in the second head-wearable device state and the determination that the wrist-wearable device is in the first wrist-wearable device state:
in response to the wrist-wearable device detecting the second voice command, invoking the AI assistant at the wrist-wearable device.
